(19) United States
(12) Patent Application Publication
(10) Pub. No.: US 2008/0224573 A1
(43) Pub. Date: Sep. 18, 2008

(54) Step motor

(76) Inventors: I-Te Chang, Taipei City (TW); Kuo-Hsin Su, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/717,031

(22) Filed: Mar. 13, 2007

(51) Int. Cl. H02K 37/14

(52) U.S. Cl. 310/49 R

(57) ABSTRACT

A step motor includes a rotor, which has a driving member and a permanent magnet set that is affixed to the driving member and has multiple magnetic poles alternatively arranged around the driving member, and two stator windings that are arranged at two opposite sides relatively to the rotor, each having a plurality of electromagnetic poles arranged at two opposite sides and controlled to alternatively attract and repulse the magnetic poles of the permanent magnet of the rotor for causing the rotor to rotate step by step.

### BACKGROUND OF THE INVENTION

1. Field of the Invention

The present invention relates to motors and more particularly, to a step motor, which eliminates biased friction during operation.

2. Description of the Related Art

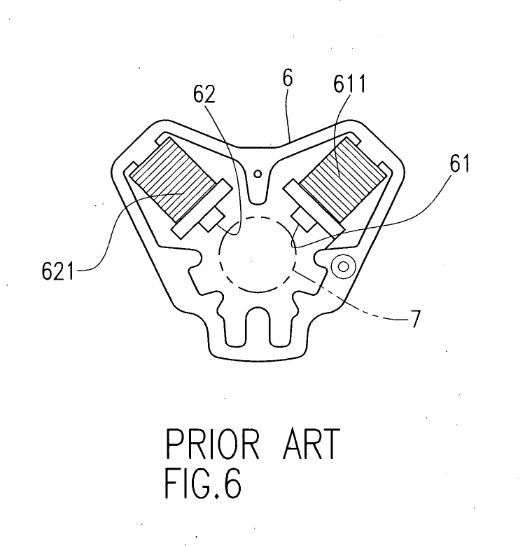

FIG. 6 illustrates a step motor according to the prior art. According to this design, the step motor comprises a stator panel 6, which has two extension portions 61 and 62, two windings 611 and 621 respectively mounted on the extension portions 61 and 62 and spaced around a rotor 7 of the step motor. When electrically connected, a driving circuit (not shown) drives the windings 611 and 621 to alternate their polarity, thereby causing the windings 611 and 621 to attract or repulse the rotor 7, and therefore the rotor 7 is rotated step by step.

According to this design, the two windings 611 and 621 are spaced from each other at right angles. Therefore, when one or both of the two windings 611 and 621 are acted upon the rotor 7, the rotor 7 with the load may vibrate at each starting or stop step. Further, because the two windings 611 and 621 are spaced from each other at right angles and controlled to attract or repulse the rotor 7, the rotor 7 is not kept in balance, and a biased friction problem of the axle of the rotor 7 is inevitable. Therefore, the axle of the rotor 7 wears quickly with use.

### SUMMARY OF THE INVENTION

The present invention has been accomplished under the circumstances in view. It is therefore one object of the present invention to provide a step motor, which uses a rotor having multiple magnetic poles to work with multiple electromagnetic poles of two stator windings to enhance the torque and stabilize the rotation. It is another object of the present invention to provide a step motor, which uses a rotor having multiple magnetic poles to work with multiple electromagnetic poles of two stator windings to keep the rotor in balance during operation, eliminating biased friction.

To achieve these and other objects of the present invention, the step motor comprises a rotor and two stator windings. The rotor comprises a permanent magnet set and a driving member axially fastened to the permanent magnet set. The permanent magnet has multiple magnetic poles alternatively arranged around the driving member. The two stator windings are arranged at two opposite sides relatively to the rotor, each having a plurality of electromagnetic poles arranged at two opposite sides and controlled to alternatively attract and repulse the magnetic poles of the permanent magnet of the rotor for causing the rotor to rotate step by step.

### 2. DESCRIPTION OF THE RELATED ART

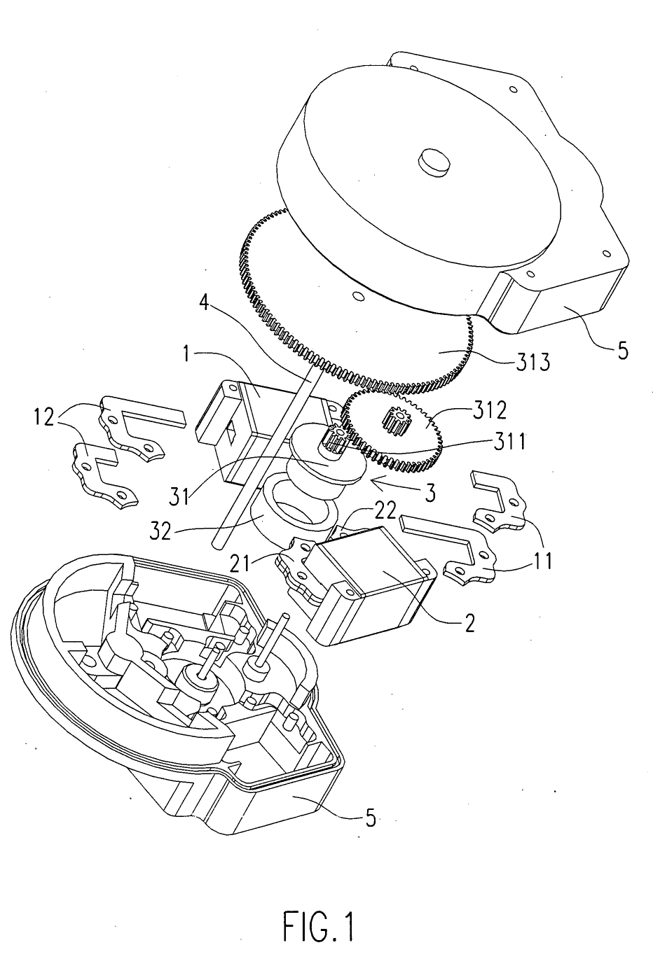

FIG. 1 is an exploded view of a step motor according to the present invention.

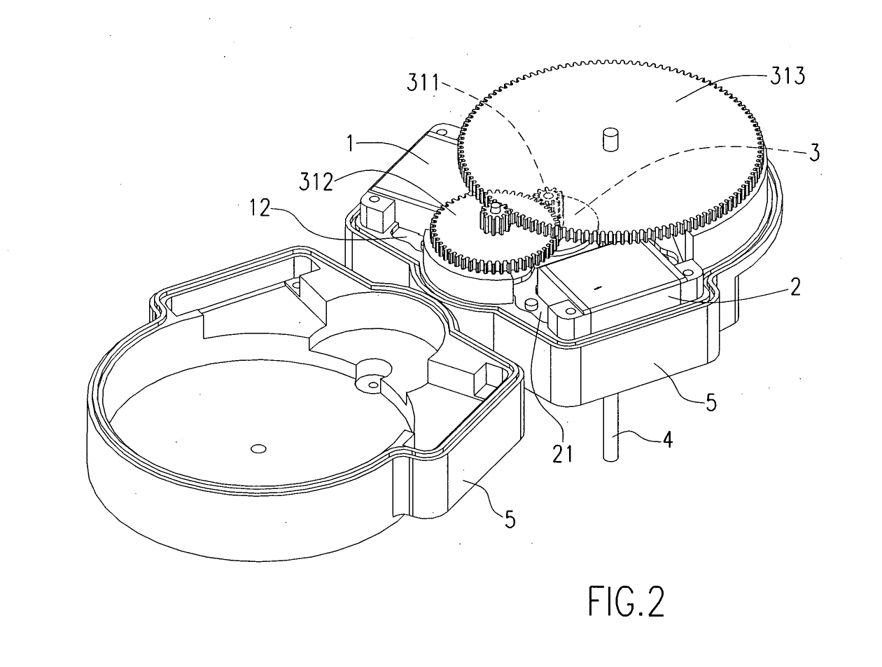

FIG. 2 is a perspective assembly view of the step motor according to the present invention before closing of the housing.

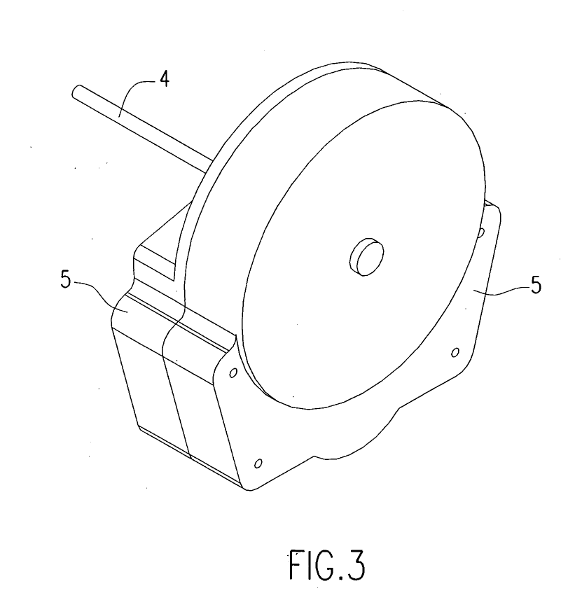

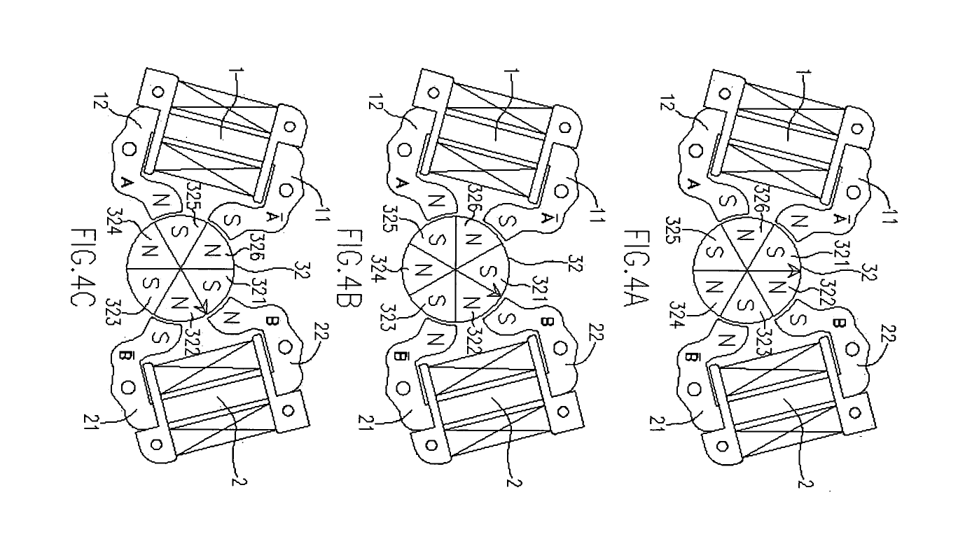

FIG. 3 is an elevational view of a step motor according to the present invention.

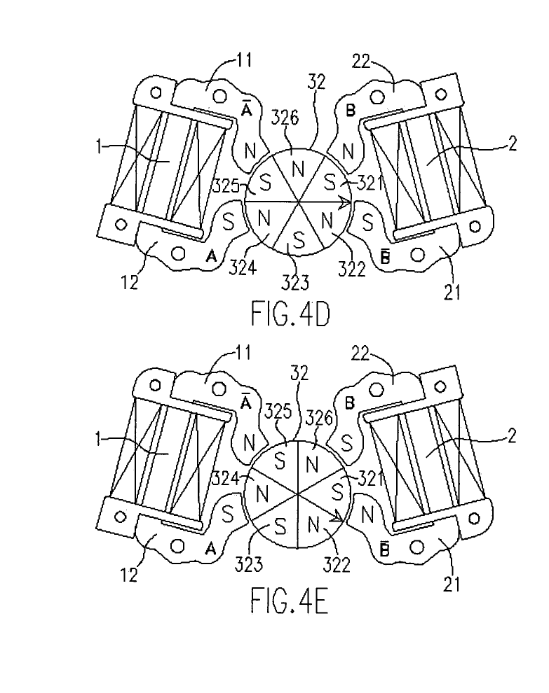

FIGS. 4A˜4E illustrates the cycling of the electromagnetic poles of the stator windings relative to the rotor according to the present invention.

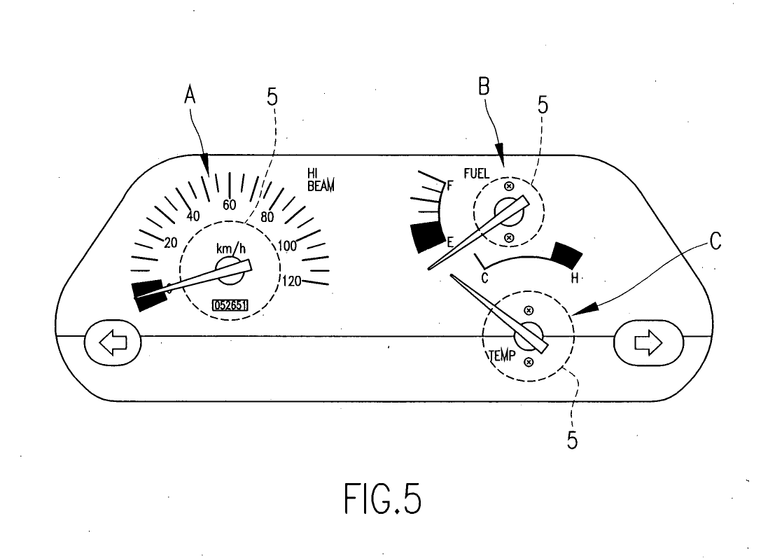

FIG. 5 illustrates an application example of the present invention.

FIG. 6 illustrates the basic structure of a step motor according to the prior art.

### DETAILED DESCRIPTION OF THE PREFERRED EMBODIMENT

Referring to FIGS. 1, 2 and 3, a step motor in accordance with the present invention is shown comprising a rotor 3, two stator windings 1 and 2, and two sets of electromagnetic poles 11 and 12; 21 and 22 respectively extended from the stator windings 1 and 2 at two opposite sides on one same plane. The rotor 3 is comprised of a driving member 31 and a permanent magnet set 32. The driving member 31 is axially fastened to the permanent magnet set 32 at the center. The driving member 31 has a pinion 311 fixedly mounted on its one end, namely, the top end for rotating a transmission gear train 312 and 313 for power output through an output shaft 4 that is fixedly connected to the center of gearwheel 313 of the transmission gear train 312 and 313. The step motor further comprises a housing 5 that houses the aforesaid component parts of the step motor. By means of the aforesaid arrangement, the step motor has a low profile, and is practical for use in a motor vehicle to rotate the index of a speedometer A, fuel indicator B, temperature indicator C, or the like (see FIG. 5).

Referring to FIG. 4A, the permanent magnet set 32 of the rotor 3 has six magnetic poles 321-326 operated under a two-phase driving control. When the stator windings 1 and 2 are electrically connected and when the electromagnetic poles 11, 12, 21, 22 are N, S, N, S respectively, the electromagnetic poles 11, 12, 21, 22 attract S, N, S, N of the magnetic poles 321, 326, 323, 322 respectively, and therefore the rotor 3 is stopped. When the electromagnetic poles 11, 12 are changed to S, N respectively, the electromagnetic poles 11, 12 repulse the S, N of the magnetic poles 321, 326, and therefore the rotor 3 is rotated through 30°, and then stopped by means of magnetic attraction between N, S of the magnetic poles 326, 325 and the S, N of the electromagnetic poles 11, 12 (see FIG. 4B). Thereafter, when the electromagnetic poles 21, 22 of the stator winding 2 are changed to S, N respectively, the electromagnetic poles 21, 22 repulse S, N of the magnetic poles 323, 322, and therefore the rotor 3 is rotated further through 30° and then stopped by means of magnetic attraction between N, S of the magnetic poles 322, 321 and the S, N of the electromagnetic poles 21, 22 (see FIG. 4C). When the electromagnetic poles 11, 12 of the stator winding 1 are changed to N, S respectively, the electromagnetic poles 11, 12 repulse N, S of the magnetic poles 326, 325, and therefore the rotor 3 is rotated further through 300 and then stopped by means of magnetic attraction between S, N of the magnetic poles 326, 325 and the N, S of the electromagnetic poles 11, 12 (see FIG. 4D). When the electromagnetic poles 21, 22 of the stator winding 2 are changed to N, S respectively, the electromagnetic poles 21, 22 repulse N, S of the magnetic poles 322, 321, and therefore the rotor 3 is rotated further through 30° and then stopped by means of magnetic attraction between S, N of the magnetic poles 321, 326 and the N, S of the electromagnetic poles 21, 22 (see FIG. 4E). At this time, the electromagnetic poles 11, 12, 21, 22 are returned to N, S, N, S respectively, completing one alternating cycle to rotate the rotor 3 through ⅓ run (120°). Therefore, the invention enables the step motor to rotate step by step at 30° per each step.

According to the aforesaid preferred embodiment of the present invention two stator windings 1 and 2 are used with the rotor 3, and the stator windings 1 and 2 each have a set of electromagnetic poles 11, 12 or 21, 22 for acting upon the multiple poles of the permanent magnet set 32 of the rotor 3.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A step motor comprising:
a rotor, said rotor comprising a permanent magnet set and a driving member axially fastened to said permanent magnet set, said permanent magnet set having multiple magnetic poles alternatively arranged around said driving member; and
two stator windings arranged at two opposite sides relatively to said rotor, said stator windings each having a plurality of electromagnetic poles arranged at two opposite sides and controlled to alternatively attract and repulse the magnetic poles of said permanent magnet of said rotor for causing said rotor to rotate step by step.

2. The step motor as claimed in claim 1, further comprising a pinion fixedly mounted on one end of said driving member, and a transmission gear train coupled to and rotatable by said pinion, and an output shaft rotated by said transmission gear train upon rotation of said pinion.

3. The step motor as claimed in claim 1, further comprising a housing that houses said rotor, said stator windings, said pinion, said transmission gear train, and said output shaft.
